(19) United States
(12) Patent Application Publication
(10) Pub. No.: US 2005/0088222 A1
(43) Pub. Date: Apr. 28, 2005

(54) Chip enabled voltage regulator

(75) Inventor: David C. McClure, Carrollton, TX (US)

Correspondence Address: Lisa K. Jorgenson, Esq.;STMicroelectronics, Inc., 1310 Electronics Drive, Carrollton, TX, 75006-5039, US

(73) Assignee: STMicroelectronics, Inc.

(21) Appl. No.: 10/695,293

(22) Filed: Oct. 27, 2003

(51) Int. Cl. G05F 1/10

(52) U.S. Cl. 327/540

(57) ABSTRACT

A voltage regulator having a plurality of current sources and adapted to make available current to a circuit, such as a memory device. One or more of the plurality of current sources is selectively enabled/disabled to provide either of two non-zero, distinct current levels to the circuit depending on a logic value of the chip enable signal. The chip enable signal is input to the circuit to enable/disable the circuit to perform various operations.

### BACKGROUND OF THE INVENTION

1. Technical Field of the Invention

The present invention relates to voltage regulation and, in particular, but not by way of limitation, to a method and system for selectively limiting the current supplied by a system power source to any of at least two distinct non-zero current levels based upon the value of an enable signal.

2. Description of the Related Art

It is well known that voltage regulators supply a current to a circuit at a substantially constant (regulated) voltage. Also, it is well known to use an enable signal for enabling a circuit to perform a predetermined function. Correspondingly, the circuit is disabled from performing a predetermined function when the enable signal changes to a disable state. Circuits typically require more current when they are enabled (and performing operations) than when they are disabled (and inhibited from doing so). For example, memory circuits require more current when they are enabled and executing memory access operations, than when they are disabled. Moreover, the aforementioned circuits utilizing enable signals may receive the signal from an external source.

Many known circuits or systems have a battery backup capability for use in the event of a power failure. Use of a backup battery during a power failure serves to avoid the unintentional loss of data and/or circuit functions. Specifically, the source of power to the circuit and/or system may be switched from an external supply to a backup battery upon the voltage level of the external supply falling below a predetermined threshold voltage. In a battery backup mode, power consumption of the circuit and/or system powered by the battery is desired to be maintained at minimum power levels in order to conserve battery power and extend battery life.

Based upon the foregoing, there is a need for a more efficient power supply system which provides and dissipates a minimum current to the circuit when the circuit is disabled, but is capable of providing sufficient current to the circuit when the circuit is enabled.

### SUMMARY OF THE INVENTION

The present invention satisfies this need by providing a voltage regulator circuit which, when a circuit receives an enable signal and is enabled thereby, can source ample current during normal operation, but is placed in a low current mode when the circuit is disabled by the enable signal. During the period when the circuit is disabled by the enable signal, the current demands on the voltage regulator are much less than when the circuit is enabled. Further, the voltage regulator circuit itself consumes less power when the circuit is disabled and thereby minimizes the current drain on the backup battery while at the same time provides a sufficient current level to the disabled circuit or system.

### BRIEF DESCRIPTION OF THE DRAWINGS

A more complete understanding of the system and method of the present invention may be obtained by reference to the following Detailed Description when taken in conjunction with the accompanying Drawings wherein:

FIG. 1 is a schematic of the chip-enabled voltage regulator according to an exemplary embodiment of the present invention in association with a circuit;

FIG. 2 is a schematic of the delay component shown in FIG. 1;

FIG. 3 is a more detailed schematic of the chip-enabled voltage regulator illustrated in FIG. 1; and

FIG. 4 is a flow chart illustrating a method for limiting the available current output from a voltage regulator according to an exemplary embodiment of the present invention.

### DETAILED DESCRIPTION

The present invention will now be described more fully hereinafter with reference to the accompanying drawings in which exemplary embodiments of the invention are shown. This invention may, however, be embodied in many different forms and should not be construed as being limited to the embodiments set forth herein. Rather, the embodiments are provided so that this disclosure will be thorough and complete, and will fully convey the scope of the invention to those skilled in the art.

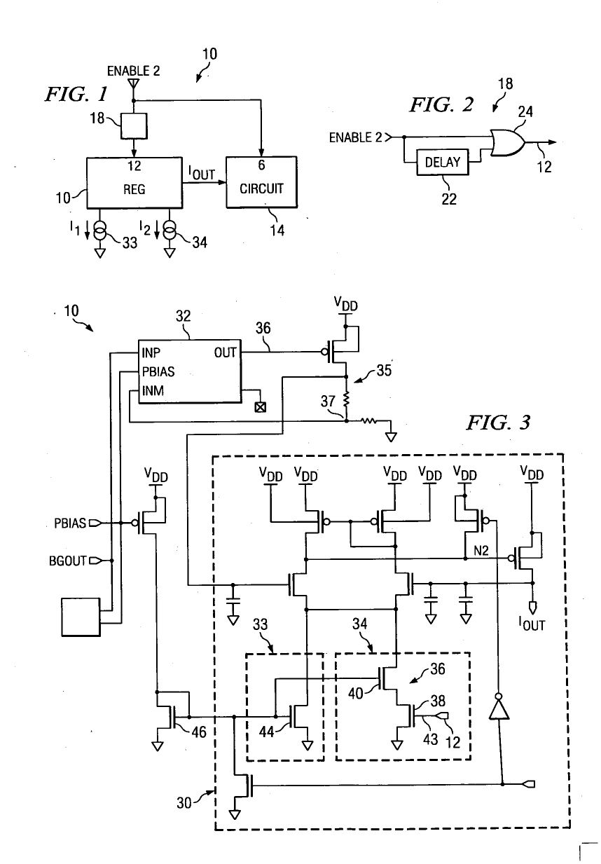

Referring to the drawings and more particularly FIG. 1, there is illustrated a voltage regulator circuit 10 which supplies current to a circuit 14. Voltage regulator circuit 10 is coupled between a system power source (not shown) and the circuit 14. According to an exemplary embodiment of the present invention, the voltage regulator circuit 10 utilizes an enable signal 2 to selectively provide either of two non-zero, distinct current levels to the circuit 14.

Voltage regulator circuit 10 may utilize enable signal 2, which in this exemplary embodiment is a chip enable signal for circuit 14, to set the current level provided thereto. Circuit 14 may comprise any circuit that utilizes an enable signal for selectively enabling the execution of predetermined operations. In an exemplary embodiment, circuit 14 may be a memory device.

At least one of a plurality of current sources 33 and 34 of voltage regulator circuit 10 is selectively enabled according to a value of the enable signal 2. When the enable signal 2 is at a disable state (for example, a logic low value), at least one of the plurality of current sources 33 and 34 is deactivated, thereby reducing the amount of current dissipated by regulator circuit 10. The available output current provided to circuit 14, which is proportional or related to the current consumed by the regulator circuit 10, is also reduced during the time enable signal 2 is in the disable state. However, when the enable signal 2 is in an enable state (logic high), circuit 14 is enabled and all of the plurality of current sources 33 and 34 are activated, thereby increasing the current dissipated by regulator circuit 10 and thus increasing the available output current (lout) of the voltage regulator 10 as a result.

A delay component 18, shown in FIG. 1, delays the provision of the low, non-zero current level to allow circuit 14 a predetermined period of time to suspend operations following enable signal 2 transitioning to the disable (logic low) state. The delay component 18 is shown in more detail in FIG. 2. The delay component 18 is coupled between the enable signal 2 and the voltage regulator 10 and may comprise a delay circuit 22 and a logical OR gate 24. The enable signal 2 is split into two signal paths, one of which is delayed by an amount relative to the delay of the other signal path. When the enable signal 2 transitions to the disable (logic low) state from the enable (logic high) state, the output of the OR logic gate 24 remains at the high logic value for a predetermined time delay of the delayed signal path. On the other hand, when the enable signal 2 transitions from the disable (logic low) state to the enable (logic high) state, the output of the OR gate 24 transitions to the logic high at approximately the same time. As a result, regulator circuit 12 is placed in the low current mode of operation for a predetermined period after circuit 14 is disabled from executing an operation, so that any predetermined operations occurring in circuit 14 that were initiated when circuit 14 was enabled may be completed before voltage regulator 10 reduces current to circuit 14.

The exemplary embodiment of the chip-enabled voltage regulator 10 according to the principles of the present invention is shown in greater detail in FIG. 3. Voltage regulator 10 may comprise a voltage follower 32 and regulator circuitry 30 which may comprise current sources 33 and 34. The regulator circuitry 30 may include transistors forming the circuitry of a differential amplifier. Current sources 33 and 34 are coupled to the differential amplifier circuitry and are adapted to provide output current (lout) to circuit 14 proportional or related to the current of the differential amplifier. The voltage follower 32 may comprise an output 36 which controls a resistive divider 35 used to set a voltage level for the regulator circuitry 10. An output 37 of the resistive divider 35 is fed back into the voltage follower 32 to regulate the voltage INM to a predetermined voltage value.

The current source 34 may comprise a first transistor 36 and a second transistor 38 coupled in series with the first transistor 36. The second current source 33 may comprise a third transistor 44. A control terminal 40 of the first transistor 36 is coupled to the control terminal the third transistor 44. Each of the current sources 33 and 34 forms a reference leg of a current mirror with transistor 46. Current source 33 is substantially continuously activated to sink current at a predetermined current level. A control terminal 43 of the second transistor 38 is connected to the output of the delay circuit 18 as shown in FIG. 1. When the output of the delay circuit 18 transitions from the enable (logic high) state to the disable (logic low) state, the current source 34 is disabled from sinking current and current source 33 makes available a first predetermined current level to the circuit 14. Conversely, when the output of the delay circuit 18 transitions from the disable (logic low) state to the enable (logic high) state, the current source 34 is enabled and, together with current source 33 makes available a second predetermined current level sufficient to allow circuit 14 to perform various functions during a normal mode of operation.

Although current sources 33 and 34 are illustrated as N-type MOS transistors, virtually any type of transistors may be used, such as bipolar transistors and P-type MOS transistors. Furthermore, more than one current source 34 may be coupled to the regulator circuitry 30 to further increase the available current when an enable signal having an enable state is provided to circuit 14 and regulator circuit 10. It is understood that regulator circuit 10 may alternatively include only a single current source, with enable signal 2 controlling (via delay component 18) the amount of current sunk thereby.

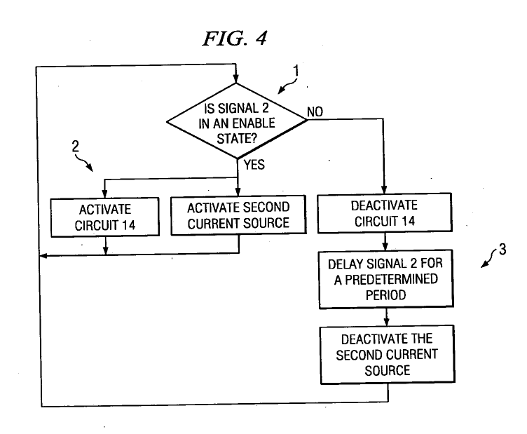

Referring now to FIG. 4, there is shown a method for limiting the available output current supplied to a circuit 14 according to the principles of the present invention. Step 1 is to determine whether or not an enable signal 2 is in the enable state. If it is, circuit 14 is enabled and current source 34 is activated at substantially the same time (step 2). Current source 34 being activated causes regulator circuit 10 to make available an increased current level (lout) sufficient to power the enabled circuit 14. In the event enable signal 2 transitions from the enable state to the disable state, current source 34 is deactivated a predetermined period following circuit 14 being disabled (step 3), thus reducing the power drain on a battery to a nominal level while sustaining data contained within the circuit 14.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A system, comprising:
a circuit receiving an enable signal the circuit enabled for an operation when the enable signal is in a first state and disabled for that operation when the enable signal is in a second state; and
a regulator circuit operable responsive to the enable signal to selectively provide a current to the circuit at a first current value when the enable signal is in the first state and at a second current value when the enable signal is in the second state.

2. The system according to claim 1, wherein the regulator circuit comprises a plurality of current sources.

3. The system according to claim 2, wherein at least one of the plurality of current sources is selectively activated by the enable signal.

4. The system according to claim 3, wherein the plurality of current sources form mirror branches of a current mirror.

5. The system according to claim 4, wherein the at least one of the plurality of current sources comprises a first transistor and a second transistor connected in series to the first transistor, wherein a control terminal of the first transistor is coupled to a control terminal of a transistor in a reference leg of the current mirror and a control terminal of the second transistor is coupled to the enable signal.

6. The system according to claim 3, further comprising a delay component responsive to the enable signal and operable to delay the activation of the at least one of the plurality of current sources relative to the enable signal being in an enabling the first state.

7. The system according to claim 6, wherein the delay component is coupled to delay application of the enable signal to the regulator circuit but not the circuit.

8. The system according to claim 6, wherein the delay component delays one of a rising edge and a falling edge of the enable signal by an amount that is greater than a delay of the other of the rising edge and the falling edge of the enable signal.

9. The system according to claim 1, wherein the circuit includes a memory device.

10. The system according to claim 9, wherein the memory device and the regulator circuit both receive the enable signal, the current value provided by the regulator circuit being based upon a value of the enable signal such that the memory device is enabled for normal operation and receives the first current value when the enable signal is in the first state and the memory device is disabled from normal operation and receives the second current value when the enable signal is in the second state.

11. A system, comprising:
a circuit with an enable signal input and operable for selectively enabling an operation to be performed in the circuit if the enable signal is in a first state and selectively disabling the operation if the enable signal is in the second state; and
a regulator circuit coupled between a system power source and the circuit and having a control input for controlling the amount of supply current available to the circuit, the control input receiving the enable signal and the regulator operating to supply a relatively higher non-zero current level to the circuit when the enable input is in the first state and supply a relatively lower non-zero current level to the circuit when the enable input is in the second state.

12. The system according to claim 11, wherein the regulator circuit comprises a plurality of current sources, at least one of the plurality of current sources is activated by the enable signal coupled to the control input of the regulator circuit.

13. The system according to claim 12, wherein the plurality of current sources form mirror branches of a current mirror.

14. The system according to claim 12, wherein the at least one of the plurality of current sources is adapted for receiving the enable signal.

15. The system according to claim 12, further comprising a delay component operable to delay the deactivation of the at least one of the plurality of current sources relative to the circuit being disabled.

16. The system according to claim 15, wherein the delay component is coupled to delay application of the enable signal to the regulator circuit.

17. The system according to claim 15, wherein the delay component delays one edge of the enable signal relative to a second edge of the enable signal.

18. The system according to claim 12, wherein the at least one of the plurality of current sources comprise a first transistor and a second transistor connected in series to the first transistor, and a control terminal of the second transistor is coupled to the enable signal.

19. The system according to claim 11, wherein the circuit includes a memory device, and the enable signal input is a chip enable input of the memory device.

20. The system according to claim 19, wherein the memory device and the regulator circuit receive the same enable signal.

21. A method, comprising the steps of:
receiving an enable signal that enables circuit operation when the enable signal is in a first state and disables circuit operation when the enable signal is in a second state; and
supplying a current to the circuit having a current level at a first value if the enable signal is in the first state and at a second value if the enable signal is in the second state.

22. The method according to claim 21, wherein the step of supplying the current further comprises the step of:
activating any one or more of a plurality of current sources in a regulator circuit so as to control the current supplied to the circuit, based on the value of the enable signal.

23. The method according to claim 22, wherein the step of supplying the current further comprises the step of delaying current source deactivation relative to the current source activation.

24. The method according to claim 21, further comprising the step of selectively enabling an operation in the circuit based on the value of the enable signal.

25. The method according to claim 24, further comprising the steps of delaying the step of supplying a current relative to the step of selectively enabling an operation.

26. (canceled).

27. A method, comprising the steps of:
coupling a system power source to a circuit;
applying an enable signal to the circuit the circuit being enabled for operation when the enable signal is in a first state and disable for operation when the enable signal is in a second state; and
selectively limiting the current supplied by the system power source to the circuit to any of at least two distinct non-zero current levels in response to the enable signal such that the system power source supplies a higher non-zero current level to the circuit if the enable signal is in the first state and supplies a lower non-zero current level to the circuit if the enable signal is in the second state.

28. The method according to claim 27, wherein the step of selectively limiting the current comprises the steps of:
coupling a regulator circuit having a plurality of current sources between the system power source and the circuit, operable to supply the current to the circuit; and
selectively activating one or more of the plurality of current sources so as to limit the current supplied to the circuit to any of the at least two distinct non-zero current levels.

29. The method according to claim 28, wherein the step of selectively activating further comprises the steps of:
selectively activating the one or more of the plurality of current sources so as to limit the current supplied to the circuit to the higher non-zero current level when the enable signal has the first state; and
selectively activating one or more of the plurality of current sources so as to limit the current supplied to the circuit to the lower non-zero current level when the enable signal has the second state.

30. The method according to claim 28, further comprising the step of delaying the current source deactivation relative to the current source activation.

31. (canceled).

32. The method according to claim 27, wherein the enable signal selectively enables a memory access operation to occur.
